(19) United States
(12) Patent Application Publication
(10) Pub. No.: US 2011/0016196 A1
(43) Pub. Date: Jan. 20, 2011

(54) METHOD AND SYSTEM TO DISCOVER AND SUBSCRIBE TO AN ENHANCED SYNDICATED FEED

(76) Inventors: Gaelle Christine Martin-Cocher, Toronto (CA); Michael Shenfield, Richmond Hill (CA)

Correspondence Address: Research in Motion Corp/SLW;Attn: Glenda Wolfe, Building 6, Brazos East, Suite 100, 5000 Riverside Drive, Irving, TX, 75039, US

(21) Appl. No.: 12/838,289

(22) Filed: Jul. 16, 2010

Related U.S. Application Data
(60) Provisional application No. 61/226,188, filed on Jul. 16, 2009.

(51) Int. Cl. G06F 15/16

(52) U.S. Cl. 709/219

(57) ABSTRACT

Embodiments of a method and system to discover and subscribe to an enhanced syndicated feed are generally described herein.

### CLAIM OF PRIORITY

This application claims the benefit of priority under 35 U.S.C. §119(e) of Martin-Cocher, Gaelle Christine, U.S. Provisional Patent Application Ser. No. 61/226,188, entitled “METHOD AND SYSTEM TO DISCOVER AND SUBSCRIBE TO AN ENHANCED SYNDICATED FEED,” filed on Jul. 16, 2009 (Attorney Docket No. 36123-US-PRV (2558.042PRV), which is hereby incorporated by reference herein in its entirety.

### FIELD OF THE DISCLOSURE

The present inventive subject matter is related to syndicated feed reception.

### BACKGROUND

Content syndication is an XML-based format that allows web developers to describe and syndicate web site content. The syndicated feed is provided by publishing a list of content in a standardized format that can then be downloaded by feed reader programs that allow users to subscribe to the feeds.

Two common syndication formats include Really Simple Syndication (RSS) and Atom. The RSS 2.0 format is published by the RSS Advisor Board at RSSboard.org and the Atom syndication format is published by the Internet Engineering Task Force (IETF) Request for Comments (RFC) 4287, the contents of which are incorporated herein by reference. Atom and RSS content complies with an Atom or RSS extensible markup language (XML) schema that provides a limited number of parameters. Such parameters describe the content and how an RSS and Atom reader can make use of it. Examples of such of parameters include: title, source, description, link, contributor, category, among others.

Atom and RSS schemas contain parameters that are used to provide a reference to additional content, such additional content being related to the syndicated feed fragment in which the reference is found. This additional content can be a media such as an audio or video, package in a file (e.g., 3GPP file format) or in a stream (RTSP); or can be an HTML page. As used herein, this additional reference is called an enclosure.

### BRIEF DESCRIPTION OF THE DRAWINGS

Some embodiments are illustrated by way of example and not limitation in the figures of the accompanying drawings in which:

FIG. 1 is a system diagram according to an example embodiment;

FIG. 2 is a data flow diagram illustrating discovering an optimized feed via a URI, according to an example embodiment;

FIG. 3 is a data flow diagram illustrating discovering an optimized feed via an HTTP response header, according to an example embodiment;

FIG. 4 is a data flow diagram illustrating discovering an optimized feed via an HTTP discovery request header, according to an example embodiment;

FIG. 5 is a data flow diagram illustrating discovering an optimized feed via a UAProf profile according to an example embodiment.

FIG. 6 is a data flow diagram illustrating transmitting media capabilities according to an example embodiment.

FIG. 7 is a block diagram of a mobile electronic device according to an example embodiment.

### DETAILED DESCRIPTION

In an embodiment current Atom or RSS feeds are retrieved by an RSS/Atom parser in an HTTP stateless pull request. The open mobile alliance (OMA) dynamic content delivery (DCD) specification (Technical specification candidate version 1.0 as of Jun. 12, 2009 available at http://www.openmobilealliance.org/) defines ways to optimize the delivery of Atom and RSS content by proxying the content on a server, such server being able to push, broadcast the content based on a variety of preferences such as delivery preferences, scheduling information, content type and mime-type of interest for a piece of user equipment (UE, e.g., a mobile electronic device) etc.

The OMA DCD specification assumes that a UE is registered to a DCD server at which the content is available. The OMA DCD specification further describes how to perform subscriptions to content channel (or feed) that are not available at the DCD server. However, DCD does not solve the problem of ad-hoc activation of the UE to the delivery server associated with discovered content and subscription to such content. For 3GPP syndicated feed reception (SFR), in an example embodiment, where such content is a syndicated feed and such server is a SFR server the problem translates into the following: when a UE discovers a feed (e.g. via a web browser) and provides the feed uniform resource identifier (URI) to the syndicated feed parser (i.e. SFR-enabled RSS or Atom parser), the feed parser should be able to determine if the feed is a regular Atom/RSS feed or if this is an SFR-optimized feed. Furthermore, in an embodiment, it should be possible at the feed discovery step to advertise available delivery methods (e.g. HTTP pull) and address/port of server at which the feed can be subscribed (subscription to the feed means ability to obtain initial content and content updates via pull, push or broadcast methods). Such information may allow an SFR-enabled feed reader to activate with and register to the previously unknown SFR delivery server and then subscribe to the discovered SFR feed to benefit of SFR-optimized delivery.

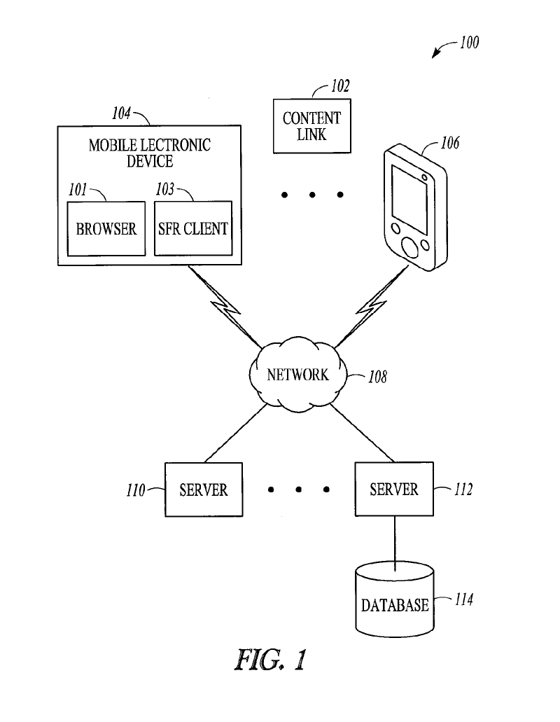

FIG. 1 is a system 100 illustration according to an example embodiment. The system 100 includes user equipment devices (e.g., mobile electronic devices 104, 106) that communicate over at least one network 108. The system 100 also includes at least one server 110, 112 that communicates over the at least one network 108.

The mobile electronic devices 104, 106 may include one or more network interface devices that are operable to communicate over the at least one network 108. The mobile electronic devices may include, but are not limited to, mobile telephones, portable computers, personal digital assistants, and other devices that may be carried by a user and provide wireless communication. Mobile telephones include wireless communication devices that have generally been referred to as cell phones. Mobile telephones may include a wide range of communication devices from portable phones with limited functionality beyond voice communication to portable phones capable of providing the functionality of a personal computer. Mobile electronic device 104 further includes a browser 101 and syndicated feed reception (SFR) client 103. The browser may be used to navigate to a data item (e.g., a web page) that includes a content link 102. The content link may identify one or more syndicated feeds managed by servers 110, 112. SFR client 103 may manage (e.g., subscribe to, communicate with one or more servers) a syndicated feed identified by the content link 102.

Connections between the mobile electronic devices 104, 106 and the at least one network 108 may include one or more wired or wireless connection possibilities. Examples of wireless connections may include connections to mobile radio networks operating at one or more frequencies according to one or more protocols of such networks (e.g., CDMA, GSM/EDGE UTRAN, E-UTRAN etc.). The wireless connections may also, or alternatively, include wireless networking connections, such as connections that provide IP connectivity (e.g., IEEE 802.11 WiFi, WiMAX, etc.). The connections may also include shorter range wireless connections to other devices that provide access to the at least one network 108. An example of such a shorter range wireless connection is a Bluetooth wireless connection to another device, such as a personal computer, that is connected to the at least one network 108. A further example of such a shorter range wireless connection is a Near Field Communication (NFC) wireless, contactless connection between mobile electronic devices 104, 106, connected to the at least one network 108. Wired connections may include a wired Ethernet connection between a mobile electronic device 104, 106 and the at least one network 108. Other connections may include a wired connection, such as a Universal Serial Bus (USB) wired connection to a USB port of a computing device in communication with the at least one network 108.

The at least one network 108 may include any number of network types, such as one or more of mobile telephone networks, wireless computer networks, and wired computer networks. The at least one network may be interconnected with one or more of the Internet, Local Area Networks (LAN), proprietary networks including content limited to access only by subscribers of particular services, and other networks. Although two servers 110, 112 are illustrated, there may instead be one server, or more than two servers.

The servers 110, 112 may provide syndicated content (also referred to as a content feed) such as an Atom/RSS feed. In an embodiment, at least one of the servers is an optimized content feed server. For example, the server may be a syndicated feed reception (SFR) server. An optimized content server is a server capable of managing optimized content feeds for multiple mobile electronic devices equipped with an SFR client. In an embodiment, the combination of an SFR server and a mobile electronic device with an SFR client allows a syndicated feed to be delivered to the mobile electronic device according to preferences related to the capabilities of the mobile electronic device and settings of a content feed provider (e.g., broadcast at night, according to a publication schedule).

The servers are accessible by the mobile electronic devices 104, 106 over the at least one network 108. Content provided by the servers 110, 112 in the form of a syndicated feed may be stored on the respective server, in another location, such as in a database 114, accessible by a server 110, 112 or elsewhere as may be retrieved by the servers 110, 112. Content provided by the servers 110, 112 may also be derived content that may be calculated, assembled, or otherwise determined by the servers 110, 112, such as in response to a query or other request received from a mobile electronic device 104, 106.

In an example use of system 100, a user discovers (e.g. via a web browser) one or more syndicated feed to which the user wants to subscribe. The SFR client receives a single uniform resource identifier (URI) as an input and determines if it is an SFR optimized feed or if it is a regular Atom/RSS feed. In an embodiment, a mobile electronic device is already connected to one or more optimized content feed servers (also referred to as SFR servers). In a further embodiment, an external channel discovery and subscription mechanism allows an SFR client to discover and subscribe to content feeds that are not available at the SFR servers it is currently connected to.

As an example, a subscription model is described using a current SFR server already associated with a mobile electronic device. An internal subscription mechanism (i.e. via an SFR client) may be used to subscribe to a content feed. As an example, the SFR client may pass a subscription request to an SFR server that subscribes to the content feed on behalf of the SFR client as described in OMA DCD specification.

In a further example, an external subscription mechanism is utilized (e.g. via a web browser) to subscribe to an external feed. Such a discovery and subscription mechanism may not involve an SFR client and may not involve the SFR server (e.g. subscription on a specified web portal), though the SFR server is notified upon the subscription and in turn notifies the SFR client to validate the subscription as described in the OMA DCD specification.

In an embodiment activation/subscription to a new SFR server may be performed in a number of ways. For example, upon discovery of an external feed, the SFR client retrieves information about the SFR server associated with the feed. The SFR client activates with this new SFR server and the SFR client further subscribes to the feed. In a further example, when discovering an external feed, the SFR client provides its information in the discovery request (e.g. via HTTP headers or UAProf) and the SFR server uses server-initiated activation to establish a corresponding relationship with this SFR client.

External Channel Discovery and Subscription Using Current SFR Server

In an internal subscription to an external channel scenario, the SFR client is already activated and registered to an existing SFR server and may already have subscribed to channels discovered via the internal discovery method. The user discovers a feed via means other than the SFR client (e.g. via a web browser) and, following the feed discovery process, the SFR client is provided with the feed URI. The SFR client relays the feed URI to the SFR server in order for the SFR server to perform a subscription to this external channel. The SFR client submits the subscription request with a message-ID, session-ID, Content-Address, and Subscription ID, if specified. The SFR server registers to the feed by exchanging a request for channel registration, a channel registration request, and a channel registration response with the content provided. A subscription request and a subscription response are also exchanged as described in OMA DCD specification.

In a scenario whereby the feed provider is not a SFR content provider and does not support the messages exchanged above, the SFR server retrieves the content from the feed provider via an HTTP GET request and inserts the relevant metadata in the feed both for optimized handling of enclosures and for optimized delivery.

In an external subscription for an external feed the user discovers a feed via other means (e.g. from a web portal) and provides the relevant information (e.g., a device context) to receive the feed on its SFR terminal as described in OMA DCD specification. The feed is routed via the SFR server to which the terminal is connected. (For instance, if a phone number is identified as belonging to a particular mobile network operator the feed provider knows the SFR server of that carrier)

External Discovery and Activation/Subscription Via a New SFR Server

In an embodiment, a user discovers a feed via means other than an SFR client (e.g. via a web browser) and, following the feed discovery, the SFR client is provided with a feed URI. The SFR Client is able to identify whether this feed is an SFR feed or a legacy Atom/RSS feed. To identify whether the feed is an SFR feed associated with a new SFR server, the SFR client and SFR server may use one of the following discovery and activation/subscription methods.

Upon discovery of an external feed, the SFR client gets information about the SFR server associated with this feed. The SFR Client initiates the activation process toward the new SFR server and subscribes to the feed. There are at least two options to disclose such information. In one embodiment, the SFR feed URI follows a predefined URI scheme that allows to specify the SFR server at which the feed is available and provide relevant connection parameters associated with the SFR server as part of feed URI. In another embodiment, the feed discovery response contains the SFR server information and connection parameters as part of the HTTP headers.

In a further example embodiment, when discovering an external feed, the SFR client in the discovery HTTP request, provides device context information (i.e. device identity and SFR capabilities). Such information may be provided using dedicated HTTP header(s) and/or attached User Agent Profile (UAProf), (e.g., either as an HTTP header or using multipart HTTP request). The SFR server (with which the external feed is associated) uses the server-initiated activation process to establish a relationship with this SFR client using provided device context to address the device. In an embodiment, the HTTP header in the discovery request contains the SFR client connection information. Upon reception of such parameters, the SFR server initiates the activation process with the SFR client. In a further embodiment, the SFR client provides the UAProf as a part of the discovery request. Upon reception of such parameters, the SFR server initiates the activation process with the SFR client. In some embodiments, the SFR server may use intermediary (e.g. another server such as delivery proxy) to perform the activation process with the SFR client.

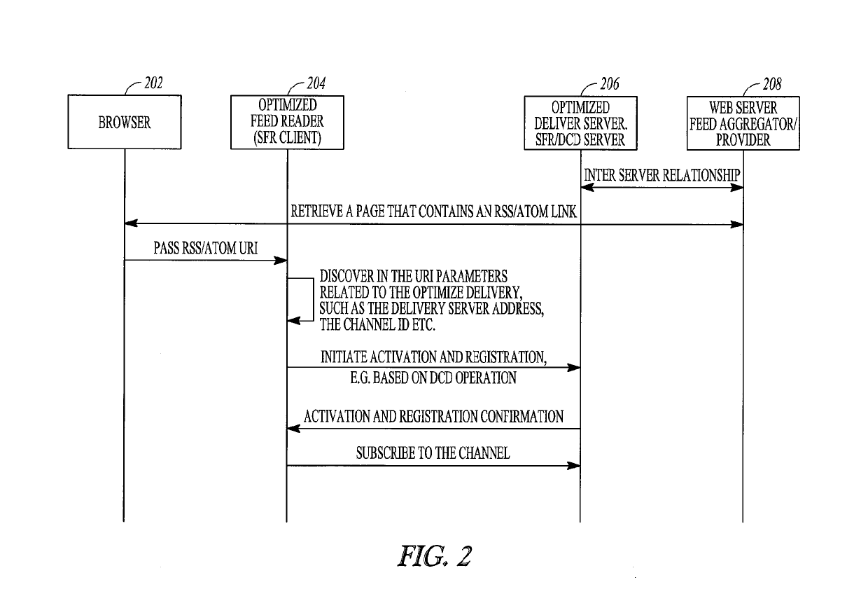

FIG. 2 is a data flow diagram illustrating discovering an optimized feed via a URI, according to an example embodiment. Illustrated is browser 202, optimized RSS/Atom parser (SFR client) 204, optimized delivery server (SFR server) 206, and web server and feed aggregator/provider 208. In an example embodiment, browser 202 and SFR client 204 reside in a mobile electronic device. In various embodiments, SFR server 206 and web server 208 may be the same machine and in other embodiment server 206 and server 208 are separate. In some embodiments, the servers 206, 208 are implemented as software. For example, the servers may be implemented inside one or more virtual machines running on a computer. In other embodiments, the functions of a web server and SFR server are spread across multiple machines or software implementations.

An SFR feed that is hosted or that can be retrieved on an SFR server may provide information within the URI for an SFR client to activate and subscribe to the required SFR server. In an embodiment, in order for SFR client to connect to a new SFR server, the following parameters are included in the URI: an SFR server address, proxy information, and data connection details. Also included is one of the following parameters to facilitate subscription to the discovered feed: a channel identifier and a content address.

In an embodiment the SFR address is the (URL) of the SFR server with which the SFR Client should activate. The proxy may be an address (IP address or hostname) of the proxy that should be used for communications with SFR server. This parameter may be omitted if no proxy is required to connect to the SFR server. The data connection details may include additional bearer-network-specific connection details e.g., APN, data connection username/password, etc. This parameter may be omitted if no additional data connection details are required to connect to the SFR server. In an embodiment the channel identifier is an identifier assigned to the channel corresponding to the discovered feed. In Atom/RSS the channel identifier parameter may correspond to feed identifier specified according to the Atom or RSS schema. The content-address may be a dedicated address (URI) associated with a discovered Atom or RSS feed. An example of SFR URI may be “http://www.SFR.org/abcTopNews ? server-ddress=‘10.24.122.26:8080’; channelID=‘abcnews.com/feedTopNews’”

According to an example embodiment, upon receipt of the parameters, the SFR client sends an activation request message to the server address retrieved as part of the URI parameters. Once the SFR client activation is complete, an SFR client sends optional registration and channel subscription request(s). The SFR client may combine all 3 requests into a single request using multipart HTTP requests. With this approach the assumption is that authentication (basic, digest, or TLS) associated with activation request is sufficient to facilitate registration and subscription combined into the single transaction with activation. In other words, as registration and subscription requests are bundled with authenticated activation request there is no need to send session ID with these requests. This may be done using HTTP POST or PUT providing appropriate parameters in the message or using HTTP GET with REST-ful approach of overloading URL with the transaction parameters. In some embodiments, logical operations of activation, registration, and subscription can be combined into a single message. This message establishes relations between the SFR client and the SFR server and specifies SFR feed of interest for the SFR client.

In the example embodiment shown in FIG. 2, the activation, registration and subscription may be achieved using DCD procedures.

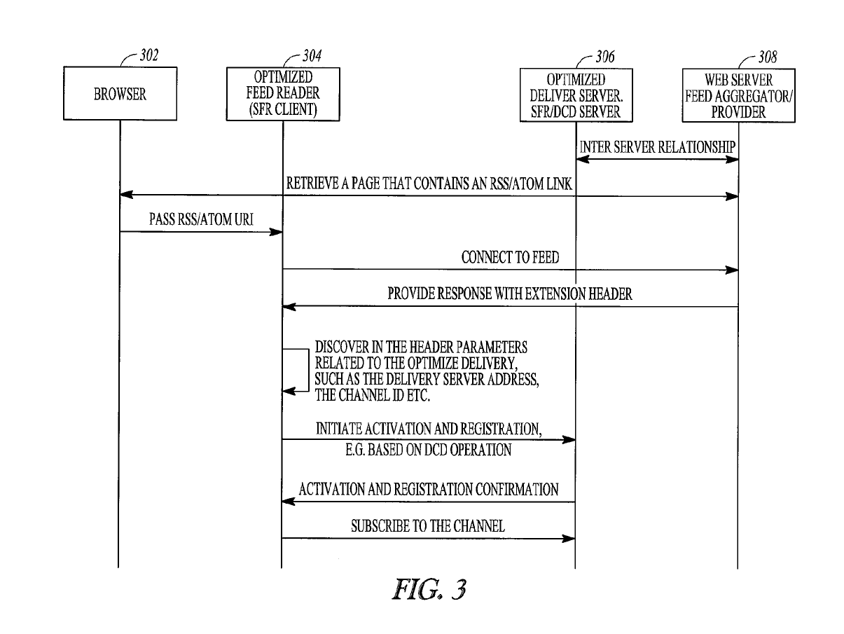

FIG. 3 is a data flow diagram illustrating discovering the details of an optimized feed via an HTTP response header, according to an example embodiment. Illustrated is browser 302, SFR optimized feed reader (SFR client) 304, optimized delivery server (SFR server) 306, and web server and feed aggregator/provider 308. In an example embodiment, browser 302 and SFR client 304 reside in a mobile electronic device. In various embodiments, SFR server 306 and web server 308 may be the same machine and in other embodiment server 306 and server 308 are separate. In some embodiments, the servers 306, 308 are implemented as software. For example, the servers may be implemented inside one or more virtual machines running on a computer. In other embodiments, the functions of a web server and SFR server are spread across multiple machines or software implementations.

In an embodiment, the browser is used to retrieve a page that contains an RSS/Atom link which is passed to the SFR optimized feed reader (SFR client). The SFR client fetches the link to get the feed. This corresponds to a discovery request to the feed provider. Upon receipt of the discovery request from an SFR client, the feed aggregator/provider provides server information and connection parameters in the HTTP header of the HTTP response as described below. In an embodiment, the SFR header indicates to the parser client that this is an SFR enabled feed. In an embodiment, the version is a required parameter for every response that carries an SFR enabled feed. In some embodiments, the feed aggregator/provider may attach such header to the initial request from the browser (e.g., if a browser request contains an indication that device is SFR-enabled). In such embodiments, the SFR client does not need to connect to the feed (as shown in FIG. 3) and can initiate activation with the SFR server according to the parameters in the header provided in response to the browser request.

SFR extension-header field:
Message-header=SFR
field-name=Version
field-name=server-address
field-name=proxy
field-name=connectionDetails

One of the two parameters to facilitate the subscription for the discovered feed:
field-name=channelID
field-name=content-address

Example of HTTP response header:

HTTP/1.1 200 OK
Content-Type: application/atom+xml; charset=UTF-8
Content-Length: 265
SFR:Version=”1.0”,server address=”10.24.122.26:8080”,
channelID=”SFR.org/abcnews.com/feedTopNews”

Upon receipt of the response parameters, the SFR client sends an activation request message to the server-address retrieved from the corresponding header parameter. Once the SFR client activation is completed, an SFR client optional registration and channel subscription request is completed. The SFR client may combine all three requests into a single request using multipart HTTP requests as previously described. In some embodiments, logical operations of activation, registration, and subscription could be combined into a single message. This message establishes relations between the SFR client and the SFR server and specifies SFR feed of interest for the SFR client.

In the example embodiment shown in FIG. 3, the activation, registration and subscription may be achieved using DCD procedures.

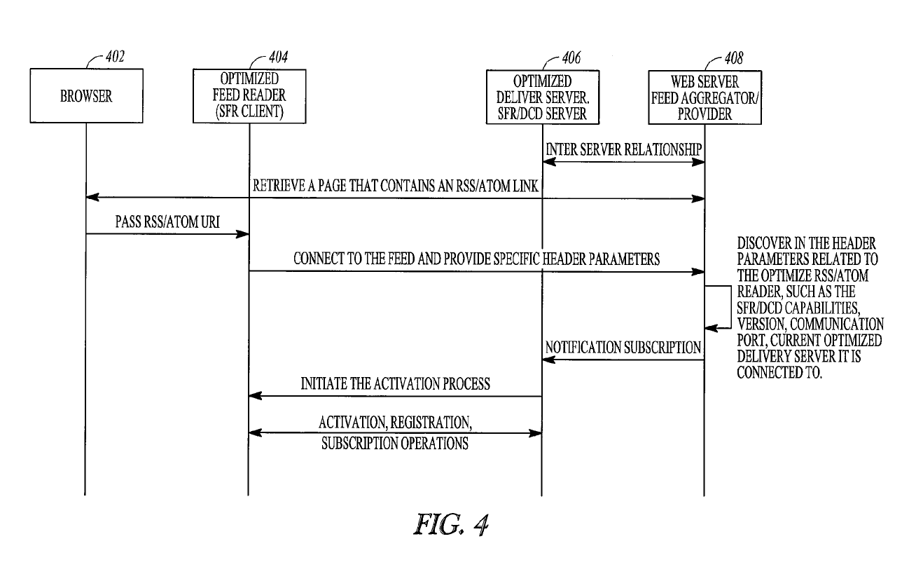

FIG. 4 is a data flow diagram illustrating discovering an optimized feed via an HTTP discovery request header, according to an example embodiment. Illustrated is browser 402, SFR optimized feed reader (SFR client) 404, optimized delivery server (SFR server) 406, and web server and feed aggregator/provider 408. In an example embodiment browser 402 and SFR client 404 reside in a mobile electronic device. In various embodiments, the SFR server 406 and web server 408 may be the same machine and in other embodiment server 406 and server 408 are separate. In some embodiments, the servers 406, 408 are implemented as software. For example, the servers may be implemented inside one or more virtual machines running on a computer. In other embodiments, the functions of a web server and SFR server are spread across multiple machines or software implementations.

As illustrated, upon discovering of a feed, the SFR client provides the following SFR parameters in the header of the HTTP discovery request to provide device context and to announce its SFR related capabilities. In an example embodiment, the SFR extension-header field comprises:
Message-header=SFR
field-name=Version
field-name=DeviceID

Example of HTTP request header:

HTTP GET version1.1
...
SFR: Version=”1.0”,DeviceID=”89302720304013462899”,
...

In an embodiment, when the SFR client sends this request to the SFR feed URI, the SFR Server associated with the SFR feed sends to the SFR client a RequestForClientActivation message. This message triggers SFR client activation with this SFR server. Once the SFR client activation is completed this is followed by an SFR client registration and channel subscription request. The SFR client may combine all three requests into a single request using multipart HTTP requests as previously described.

In the example embodiment shown in FIG. 4, the activation, registration and subscription may be achieved using DCD procedures.

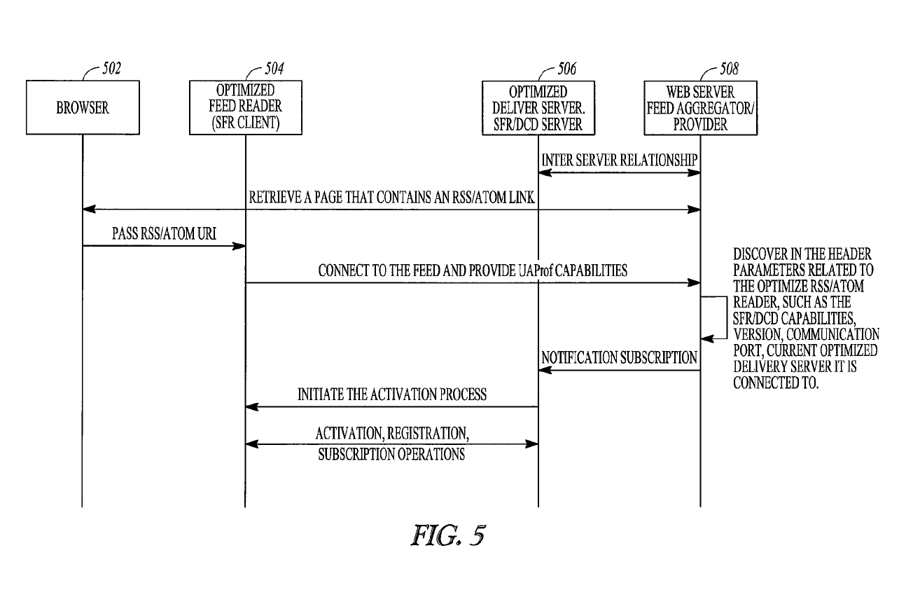

FIG. 5 is a data flow diagram illustrating discovering an optimized feed via a User Agent Profile (UAProf), according to an example embodiment. A UAProf may describe the capabilities of a mobile handset, including, but not limited to, vendor, model, screen size, and multimedia capabilities. Illustrated is browser 502, SFR optimized feed reader (SFR client) 504, optimized delivery server (SFR server) 506, and web server and feed aggregator/provider 508. In an example embodiment, browser 502 and SFR client 504 reside in a mobile electronic device. In various embodiments, SFR server 506 and web server 508 may be the same machine and in other embodiment server 506 and server 508 are separate. In some embodiments, the servers 506, 508 are implemented as software. For example, the servers may be implemented inside one or more virtual machines running on a computer. In other embodiments, the functions of a web server and SFR server are spread across multiple machines or software implementations.

In an embodiment the SFR client passes the UAProf with the following extensions when sending the HTTP GET discovery request message to the feed URI. A UAProf
Attribute=SFR Version
Attribute=DeviceID

Upon receipt of the extended UAProf, the new SFR server sends to the SFR client a RequestForClientActivation message as specified. This is followed by an SFR client optional registration and channel subscription request. The SFR client may combine all three requests into a single request using multipart HTTP requests as previously described. In some embodiments, logical operations of activation, registration, and subscription could be combined into a single message. This message establishes relations between the SFR client and the SFR server and specifies SFR feed of interest for the SFR client.

In the example embodiment shown in FIG. 5, the activation, registration and subscription may be achieved using DCD procedures.

Alternative Enclosures in Content Feed

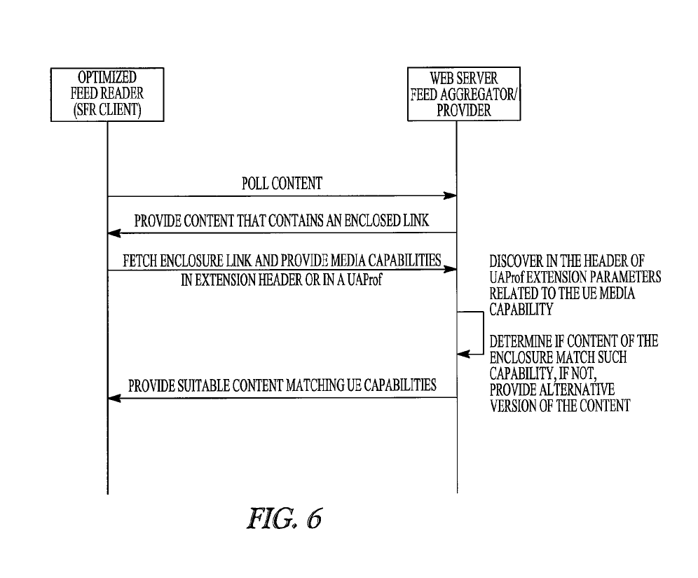

In the 3GPP SFR specification, an alternative enclosure may be defined, allowing to specify the mime-type, codec and parameters that relate to the content to be retrieved. FIG. 6 illustrates an example system in which a client announces the accepted media capabilities. In the case a feed is not provided via an SFR delivery server and contains such enclosures, the SFR client can declare supported media capabilities via an attached UAProf passed as an HTTP header in the request or via HTTP “accept” header utilizing media type declaration described in RFC 4281. The feed server receiving this HTPP request may then be able to determine if the content that is requested is in a suitable format or if an alternative version should be provided. If a suitable format is found, a response may be sent in the appropriate format.

In an embodiment in which a header is used, the “accept header” from RFC 2616 is used with the following field and values when fetching a feed enclosure:
Message header=Accept
media-range=Should be used to indicate both the mime type and codec parameters as they are defined in RFC 4281 or 3GPP PSS specification.
q=can be used to announce the level of preference for supported media if multiple content versions are available.

An example of an “accept header” that be used when fetching an enclosure or alternative enclosure is:

HTTP GET version 1.1
. . .
Accept: Video/3GP;H263/level1,3GP/Video;H264;Level=2

Audio/3GP;samr,
Image/png,Image/gif,

An example of a UAProf that may be used to declare supported mimetype may be extended with codec parameters as par RFC4281:

<prf:CcppAccept>

<rdf:Bag>

<rdf:li>audio/3gpp; codecs=”amr”</rdf:li>
<rdf:li>image/gif</rdf:li>
<rdf:li>video/3gpp; codecs=″s263, samr″ </rdf:li>
<rdf:li>video/3GPP2; codecs=″mp4v.20.9, mp4a.E1</rdf:li>

</rdf:Bag>

</prf:CcppAccept>

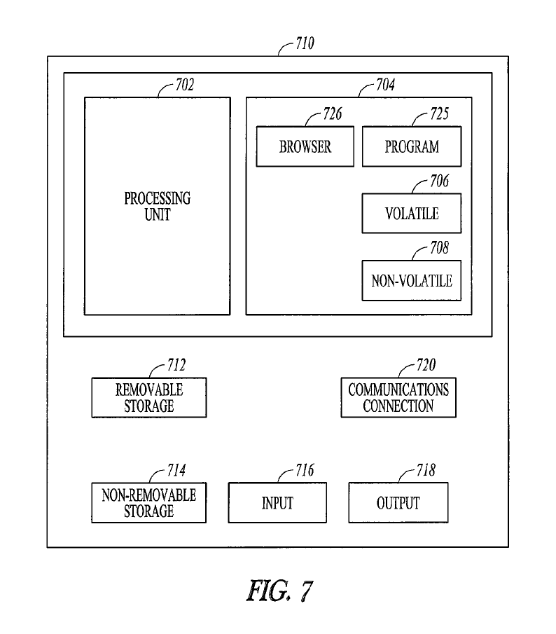

FIG. 7 is a block diagram of a computing device according to an example embodiment. In one embodiment, multiple such computer systems are utilized in a distributed network to implement multiple components in a transaction based environment. An object-oriented, service-oriented, or other architecture may be used to implement such functions and communicate between the multiple systems, devices, and components, such as in a networked computing environment described above with regard to the system 100 of FIG. 1.

One example computing device is in the form of a mobile electronic device 710. The mobile electronic device 710 is an example of the mobile electronic devices 104, 106 described above with regarding FIG. 1. The mobile electronic device 710 may include a processing unit 702, memory 704, removable storage 712, and non-removable storage 714. The processing unit 702 may include one or more processing units or may include one or more multiple-core processing units. Memory 704 may include volatile memory 706 and non-volatile memory 708. Mobile electronic device 710 may include a variety of device-readable media, such as volatile memory 706 and non-volatile memory 708, removable storage 712 and non-removable storage 714. The storage may include random access memory (RAM), read only memory (ROM), erasable programmable read-only memory (EPROM) & electrically erasable programmable read-only memory (EEPROM), flash memory or other memory technologies, or any other medium capable of storing machine-readable instructions and data that may be present in a mobile electronic device. Mobile electronic device 710 may include input 716, output 718, and a communication connection device 720.

The mobile electronic device 710 typically operates in a networked environment using the communication connection device 720 to connect to one or more networks, such as network 108 described above with regard to FIG. 1. Through the communication connection device 720, the mobile electronic device 710 may connect to one or more remote computers. The remote computer may include a personal computer (PC), server (such as servers 110, 112, also described with regard to FIG. 1), router, network PC, a peer device or other common network node, or the like. The communication connection device 720 may connect to various network types that may include a wireless telephone network, a Local Area Network (LAN), a Wide Area Network (WAN), the Internet, a proprietary subscription-based network, or other networks. The mobile electronic device 710 also may include wireless telephone capabilities to provide voice telephone service via a wireless telephone network.

Machine-readable instructions stored on a machine-readable medium are executable by the processing unit 702 of the mobile electronic device 710. The memory 704, removable storage 712, and non-removable storage 714 are some examples of articles including a machine-readable medium. For example, a program 725 with instructions that may be executed by the processing unit 702 to cause the mobile electronic device 710 to perform one or more of the methods described herein may be stored on a machine-readable medium, such as the memory 704. Other programs 725 may also be stored on a machine-readable medium, such as a browser application 726 providing web browsing functionality of the mobile electronic device 710. Further, the programs 725 may include an SFR client application that may be operates to subscribe to one or more SFR servers.

Another embodiment is in the form of a computing device, such as a mobile electronic device. The computing device in this embodiment includes at least one processor, at least one memory device, a network interface device, and a user interface device (e.g., display device). Stored in the at least one memory device is a SFR client application, and a browser application. In an example embodiment, the SFR client application is an application that is executable to manage SFR feeds.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method in a mobile device, the method comprising:
receiving a uniform resource indicator (URI) to a content feed at a feed reader;
retrieving parameters from the URI related to a content feed server providing optimized reception of one or more content feeds; and
subscribing to the content feed at the content feed server.

2. The method of claim 1, further comprising:
communicating with the content feed server based on the parameters.

3. The method of claim 2 wherein the content feed server provides an optimized delivery of content feed.

4. The method of claim 1, further comprising performing one or more of an activation operation and a registration operation.

5. The method of claim 4, wherein at least one of the operations are performed according to OMA DCD specification.

6. The method of claim 1, wherein retrieving parameters from the URI comprises:
retrieving one or more of the content feed server address, a delivery server address, a proxy address, data connection parameters, a channel identifier and a content address.

7. The method of claim 6, wherein the parameters retrieved by the mobile electronic device relate to a syndicated feed reception (SFR) server.

8. The method of claim 1 wherein the feed reader is a syndicated feed reception (SFR) enabled feed reader.

9. The method of claim 1, further comprising:
receiving an enclosure link from the content feed; and
sending media capabilities of the mobile electronic device to a content feed provider or to a content feed server.

10. The method of claim 9, wherein sending media capabilities of a mobile electronic device comprises:
sending at least one of codec and codec parameters that relate to content to be retrieved.

11. The method of claims 9 further comprising:
sending the media capabilities in a user agent profile included in HTTP header.

12. A machine-readable medium with a set of instructions stored thereon, which when executed, cause a processor to perform the method of claims 1.

13. A method at a content feed server comprising:
receiving from a feed reader a message comprising one or more parameters related to a mobile electronic device;
retrieving the one or more parameters in the message; and
sending to the feed reader a request for activation.

14. The method of claim 13, wherein retrieving the one or more parameters in the message further comprises retrieving parameters from an Hypertext Transfer Protocol header.

15. The method of claim 13, wherein retrieving the one or more parameters in the message further comprises retrieving parameters from a user agent profile.

16. The method of claim 13, wherein retrieving parameters in the message comprises:
retrieving a syndication feed reception version.

17. The method of claim 13, further comprising:
receiving media capabilities of the mobile electronic device;
formatting a response according to the media capabilities of the mobile electronic device; and
sending the response.

18. The method of claim 17, wherein receiving media capabilities of a mobile electronic device comprises:
receiving the media capabilities in a user agent profile passed as an Hypertext Transfer Protocol header.

19. The method of claim 17, wherein receiving media capabilities of a mobile electronic device comprises:
receiving accepted mime-type, codec and parameters of the codecs.

20. The method of claim 17, wherein RFC4281 is used to describe the media capabilities of the device.

21. A machine-readable medium with a set of instructions stored thereon, which when executed, cause a processor to perform the method of claim 13.

22. A method on a mobile device, to subscribe to a content feed for optimized delivery, the method comprising:
receiving a uniform resource indicator (URI) to a content feed at a feed reader;
fetching the URI, wherein fetching the URI comprises providing device parameters; and
receiving at the feed reader a request to activate to a content feed server, wherein the content feed server provides optimize delivery of the content feed.

23. The method of claim 22, wherein providing device parameters comprises:
providing parameters in a Hypertext Transfer Protocol message.

24. The method of claim 22, wherein the device parameters consist of a user agent profile.

25. The method of claim 22, wherein the device parameters comprise a syndication feed reception (SFR) version.

26. A machine-readable medium with a set of instructions stored thereon, which when executed, cause a processor to perform the method of claim 22.

27. A machine-readable medium with a set of instructions stored thereon, which when executed, perform:
receiving a message from a mobile electronic device;
retrieving parameters in the message comprising a device context;
transmitting instructions to a content feed server, wherein the content feed server provides optimized delivery of content feed; and
providing the device context to initiate a subscription between the mobile electronic device and the content feed server for an optimized delivery of the content feed.

28. A mobile device comprising:
a feed reader configured to:
receive a uniform resource indicator (URI) related to a content feed;
determine from the URI whether the content feed is a syndicated feed reception (SFR) feed as distinguished from a legacy ATOM or RSS feed;
if the content feed is an SFR feed, determine from the URI an address and connection parameters of a content feed server providing the SFR feed; and
communicate with the content feed server providing the SFR feed using the address and connection parameters from the URI.

29. The mobile device of claim 28 wherein the feed reader is configured to communicate with the content feed server to activate reception of the SFR feed from the content feed server.

30. The mobile device of claim 28 wherein the feed reader is configured to communicate with the content feed server to register with the content feed server to receive the content feed.

31. The mobile device of claim 28 wherein the feed reader is configured to communicate with the content feed server to subscribe to a channel of the SFR feed.

32. The mobile device of claim 28 wherein the feed reader is configured to communicate with the content feed server to activate and register with the content feed server and to subscribe to a channel of the SFR feed from the content feed server.

33. The mobile device of claim 28 wherein the feed reader is configured to render the communication with the content feed server to activate, register and subscribe in compliance with OMA DCD specification.

34. The mobile device of claim 28 wherein the feed reader is configured to communicate with the content feed server by generating an HTTP request including the address and connection parameters from the URI, and indicating device media capabilities including codec and codec parameters related to the content in the SFR feed.

35. The mobile device of claim 28 wherein the feed reader is configured to communicate with the content feed server by generating an HTTP request including the address and connection parameters from the URI, and indicating device media capabilities in a user agent profile in a header of the HTTP request.

36. A machine-readable medium with a set of instructions stored thereon, which when executed by a processor, perform:
receive a uniform resource indicator (URI) related to a content feed;
determine from the URI whether the content feed is a syndicated feed reception (SFR) feed as distinguished from a legacy ATOM or RSS feed;
if the content feed is an SFR feed, determine from the URI an address and connection parameters of a content feed server providing the SFR feed; and communicate with the content feed server providing the SFR feed using the address and connection parameters from the URI.
